(19) United States
(12) Patent Application Publication
(10) Pub. No.: US 2014/0096316 A1
(43) Pub. Date: Apr. 10, 2014

(54) PORTABLE BIDET SPRAYER

(71) Applicant: Chao-Chung WU, Taichung (TW)

(72) Inventor: Chao-Chung WU, Taichung (TW)

(21) Appl. No.: 13/647,290

(22) Filed: Oct. 8, 2012

(51) Int. Cl. A61H 35/00

(52) U.S. Cl. 4/443

(57) ABSTRACT

A portable bidet sprayer comprises a container, a pressure element, a fixation mechanism, and a spraying device. The container has a receiving space. The pressure element comprises a first end and a second end. The pressure element is able to move upwards and downwards between a first position and a second position with respect to the container. The pressure element is selectively fixed in the second position by the fixation mechanism. The spraying device is disposed in the container. Whereby, the first end of the pressure element does not protrude from the container too much, so the portable bidet sprayer is convenient to be taken with users. After bowel movement, users can rinse their anuses manually by the portable bidet sprayer.

### BACKGROUND OF THE INVENTION

1. Field of the Invention

The present invention relates to a sprayer, and more particularly to a portable bidet sprayer for rinsing anus.

2. Description of the Prior Art

Bidet toilet is a kind of excellent invention for rinsing anus automatically. However, it is a power consumption device and its structure is so complex that the production cost is high. That's why public places do not install bidet toilets. Visitors do not rinse their anuses by the bidet toilets in the public places, they must wipe their anuses by tissue paper after bowel movement.

The present invention is, therefore, arisen to obviate or at least mitigate the above mentioned disadvantages.

### SUMMARY OF THE INVENTION

The main object of the present invention is to provide a portable bidet sprayer which is used for rinsing anus manually after bowel movement.

To achieve the above and other objects, a portable bidet sprayer of the present invention comprises a container, a pressure element, a fixation mechanism, and a spraying device.

The container has a receiving space adapted for containing liquid.

The pressure element is disposed in the container and comprises a first end and a second end. The first end of the pressure element is located outside of the container. The second end of the pressure element is located inside of the container. The pressure element is able to move upwards and downwards between a first position and a second position with respect to the container. The first end of the pressure element is away from the container when the pressure element is located in the first position. The first end of the pressure element abuts against the container when the pressure element is located in the second position.

The fixation mechanism is disposed on the container. The pressure element is selectively fixed in the second position by the fixation mechanism.

The spraying device is disposed in the container and comprises a control valve and a nozzle. After the control valve is opened, the liquid in the receiving space flows to the nozzle by pressure change and sprays out from the nozzle.

The pressure element is fixed in the second position by the fixation mechanism, whereby the pressure element is received in the container and the first end of it does not protrude from the container too much, so the portable bidet sprayer is convenient to be taken with users. After bowel movement, users can rinse their anuses manually by the portable bidet sprayer, and the pressure element does not influence spraying action in the operation process.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a cross-sectional view of the present invention showing a pressure element located in a first position;

FIG. 4 is a cross-sectional view of the present invention showing a pressure element located in a second position;

FIG. 5 is a schematic drawing showing liquid sprayed out from a container by a spraying device;

FIG. 6 is a partial view of the present invention;

FIG. 7 is a schematic drawing showing a container turned upside down and a pipe bended by a weight member;

FIG. 8 is a partial cross-sectional view showing a pressure element located in a first position;

FIG. 9 is a partial enlargement of FIG. 8;

FIG. 10 is a partial cross-sectional view showing a pressure element located in a second position.

### DETAILED DESCRIPTION OF THE PREFERRED EMBODIMENTS

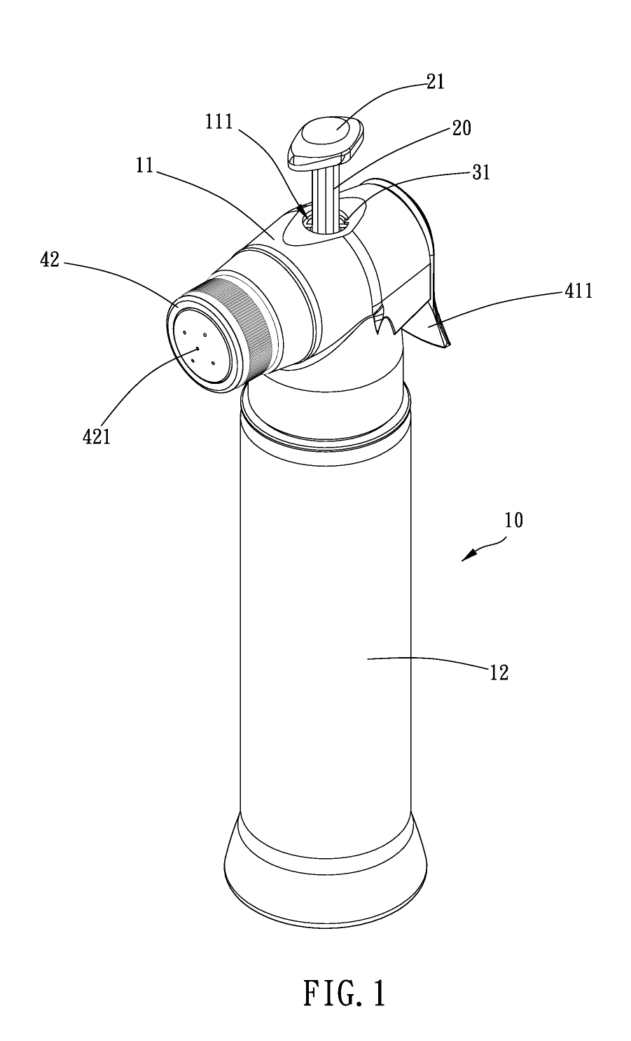

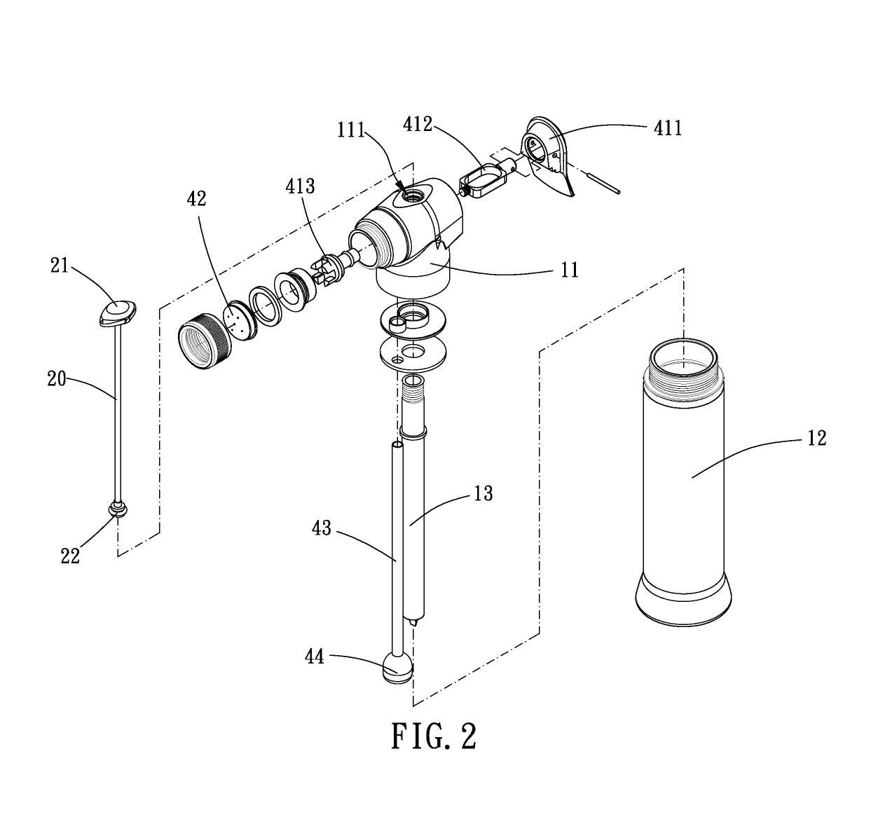

Please refer to FIG. 1 to FIG. 3. A portable bidet sprayer of the present invention is provided. The portable bidet sprayer comprises a container 10, a pressure element 20, a fixation mechanism and a spraying device.

The container 10 includes a head portion 11, a bottle 12, a pipe 13 and a check valve 14. The head portion 11 is mounted on a top portion of the bottle 12. A top surface of the head portion 11 is formed with a receiving groove 111 thereon. Two lateral sides of the head portion 11 are respectively formed with an opening. Inside of the head portion defines a channel close to one of the openings. The bottle 12 defines a receiving space 121 adapted for containing liquid. Generally speaking, the liquid is, but not limited to, pure water. Also, some healthy additives are added in the pure water for rinsing anus. The pipe 13 has a first end and a second end. The first end of the pipe 13 is threaded into the head portion 11, the second end of the pipe 13 is inserted into the receiving space 121. The pipe 13 is in communication between the receiving groove 111 and the receiving space 121. The check valve 14 is disposed at the second end of the pipe 13. More definitely, the check valve 14 comprises a base portion 141 and a duckbill portion 142. The base portion 141 is disposed at the second end of the pipe 13. The duckbill portion 142 extends from the base portion 141 and gradually narrows down towards a bottom portion of the bottle 12.

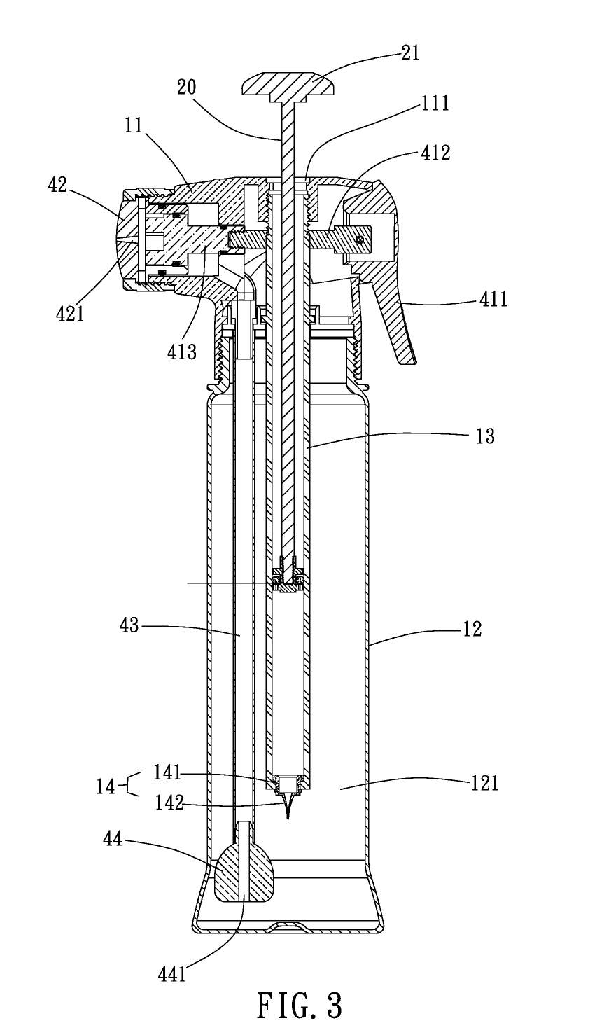

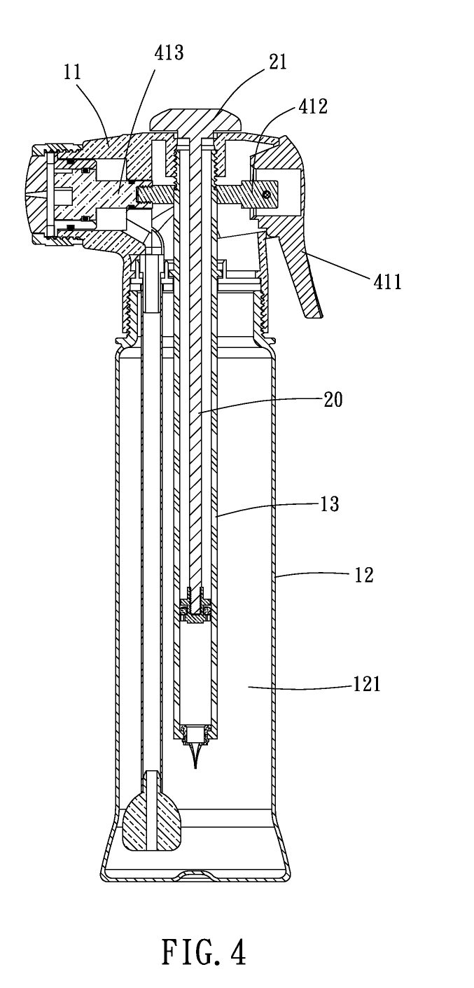

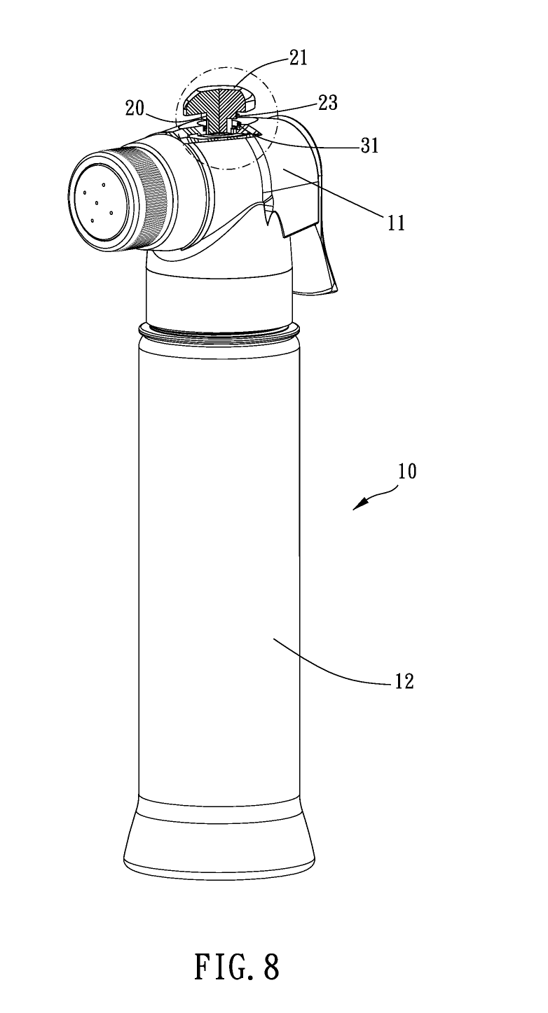

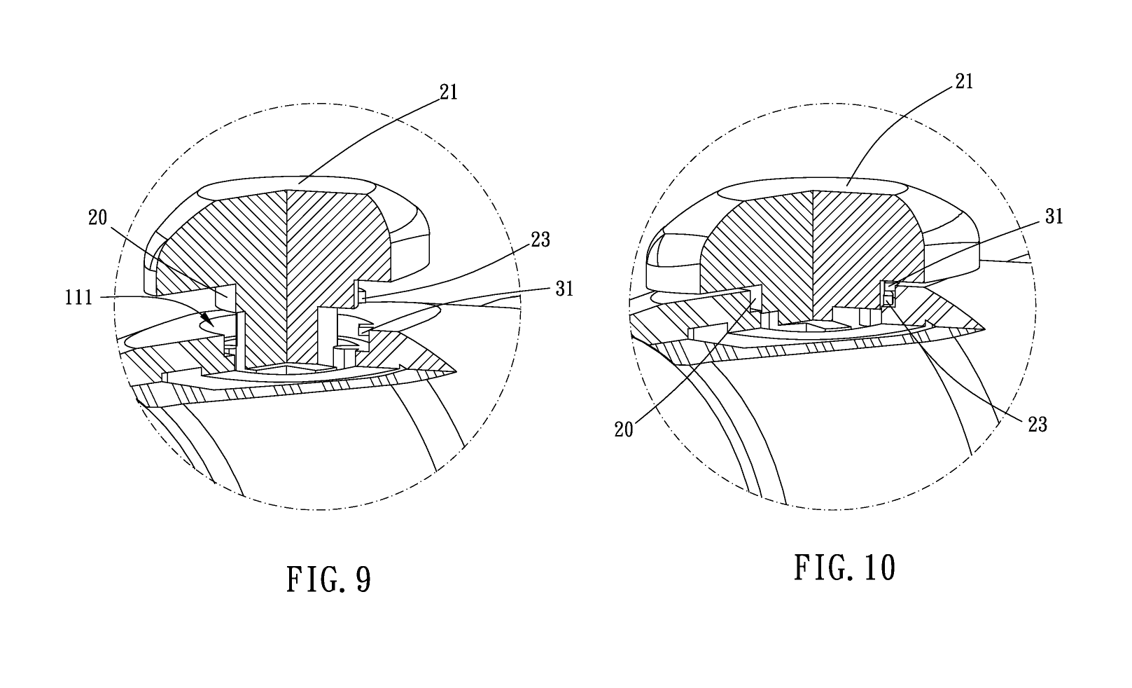

The pressure element 20 penetrates the receiving groove 111 and is received in the pipe 13. The pressure element 20 includes a first end 21 and a second end 22. The first end 21 of the pressure element 20 protrudes from the receiving groove 111 and is located outside of the bottle 12. The second end 22 of the pressure element 20 is located inside of the container 10, more specifically inside of the pipe 13. That is to say, a part of the pressure element 20 is received in the pipe 13. The pressure element 20 is able to move upwards and downwards between a first position and a second position with respect to the container 10. The first end 21 of the pressure element 20 is away from the head portion 11 in a distance when the pressure element 20 is located in the first position, as shown in FIG. 1 and FIG. 3. The first end 21 of the pressure element 20 abuts against the top surface of the head portion 11 when the pressure element 20 is located in the second position, as shown in FIG. 4. Users can push the pressure element 20 to move between the first and second positions back and forth, so outside air is pushed into the receiving space constantly and increases the atmospheric pressure of the receiving space. Preferably, the first end 21 of the pressure element 20 has a rhomboid pushing member. The rhomboid pushing member is adapted for a finger comfortably touching thereon. The top surface of the head portion 11 has a supporting surface, whose shape corresponds to the pushing member, i.e., the supporting surface is rhomboid too. As the pressure element 20 is located in the second position, a bottom portion of the pushing member abuts to the supporting surface. The pressure element 20 comprises an abutting member 23 extending therefrom radially. The abutting member 23 is adjacent to the first end 21 of the pressure element 20, as shown in FIG. 1, FIG. 8 and FIG. 9. Preferably, the pressure element 20 is able to rotate around an axis with respect to the container 10.

The fixation mechanism is disposed on the container 10. The pressure element 20 is selectively fixed in the second position by the fixation mechanism, i.e., the fixation mechanism is mainly used for fixing and keeping the pressure element 20 in the second position. Please refer to FIG. 8 to FIG. 10, in this embodiment, the fixation mechanism comprises a limiting member 31 extending from an inner side wall of the receiving groove radially. After the pressure element 20 is located in the second position and further rotates around the axis in a distance, a top portion of the abutting member 23 abuts against a bottom portion of the limiting member 31, as shown in FIG. 10. Whereby, the pressure element 20 is fixed and kept in the second position by the limiting member 31. The pressure element 20 is able to further rotate around the axis in a distance till the abutting member 23 is away from the limiting member 31, whereby the pressure element 20 isn't restricted by the limiting member 31 and is capable of moving towards the first position.

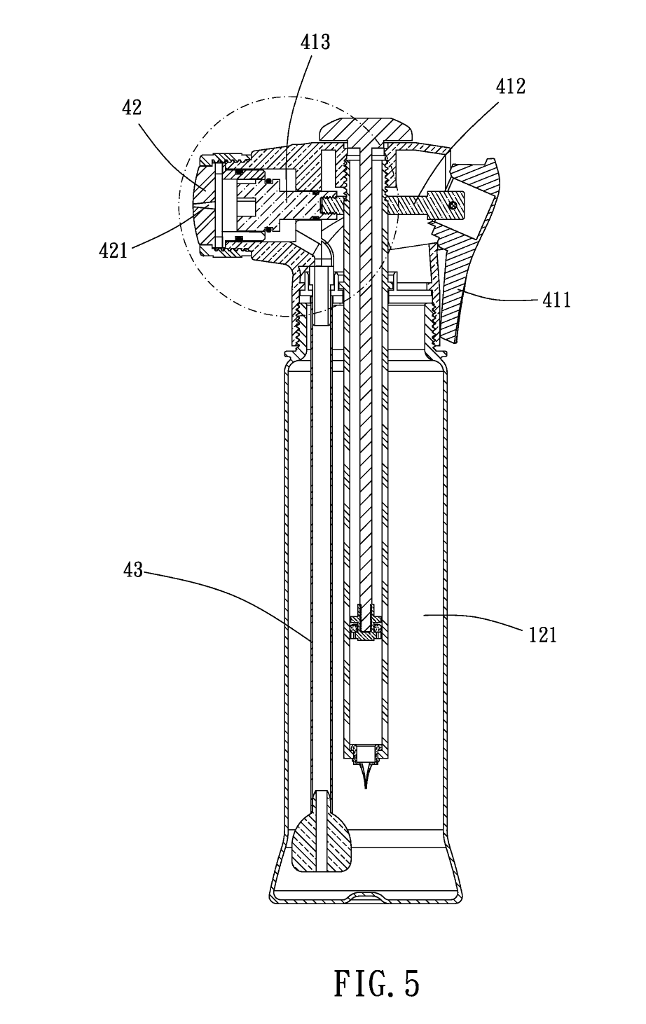

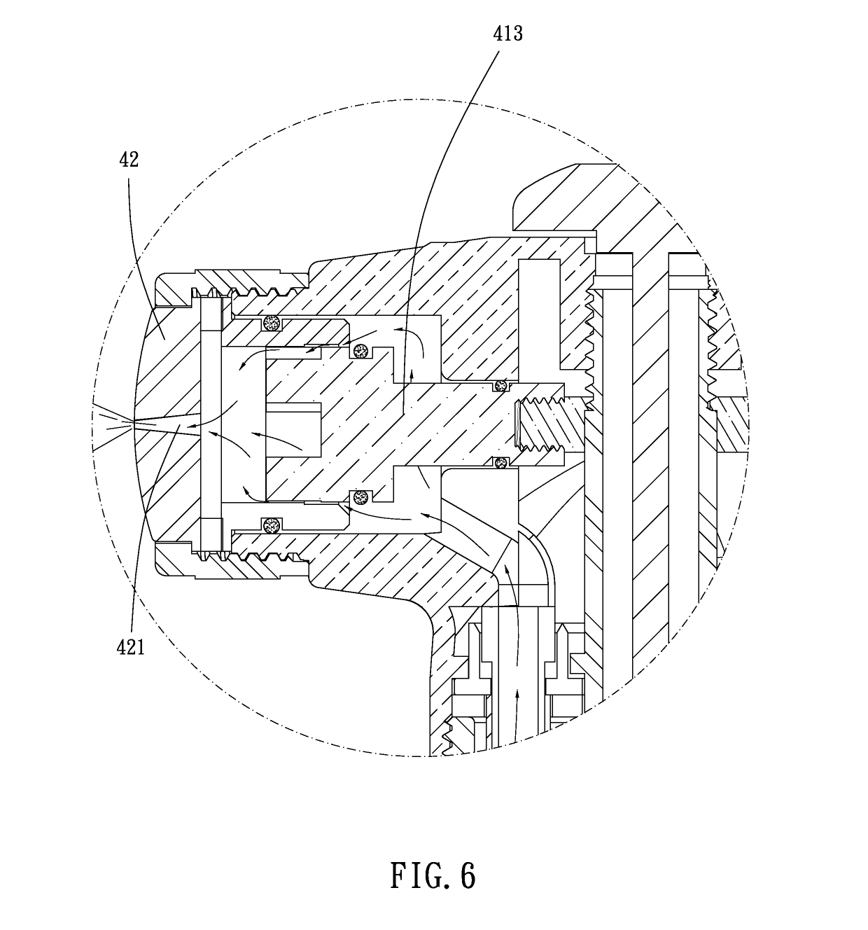

The spraying device is disposed in the container 10. The spraying device comprises a control valve, a nozzle 42, a guide tube 43 and a weight member 44. The control valve includes a pressing switch 411, a connecting element 412 and a valve body 413. The pressing switch 411 is disposed in one of the openings of the head portion 11. The valve body 413 is disposed inside of the head portion 11, and one end of it selectively opens or closes the channel. The connecting element 412 connects between the pressing switch 411 and the valve body 413. The nozzle 42 is disposed in the other one of the openings of the head portion 11. The nozzle 42 has a plurality of apertures 421. The guide tube 43 is selectively in communication between the channel and the receiving space 121. Preferably, the guide tube is flexible. The weight member 44 is disposed at a bottom end of the guide tube 43. The weight member 44 is formed with a through hole 441 in communication between inside of the guide tube 43 and receiving space 121. The pressing switch 411 drives the valve body 413 to move between an open position and a close position by the connecting element 412. As the valve body 413 is located in the open position, it doesn't close the channel. In this way, the channel communicates between the apertures 421 of the nozzle 42 and the guide tube 43. Because the atmospheric pressure of the receiving space 121 is higher than that of outside air, the atmospheric pressure of the receiving space 121 will decrease gradually till it is the same as that of the outside air. During the pressure reduction phase, the liquid in the receiving space 121 flows through the guide tube 43 and the channel to the nozzle 42 by pressure change and sprays out from the apertures 421 of the nozzle 42 constantly until the atmospheric pressure of the receiving space 121 the same as that of the outside air, as shown in FIG. 5 and FIG. 6. As the valve body 413 is in the close position, the valve body 413 closes the channel, and the portable bidet sprayer stops spraying, as shown in FIG. 4.

Whereby, the portable bidet sprayer of the present invention pushes outside air into the receiving space 121 by the pressure element 20 to enhance the atmospheric pressure of the receiving space 121. And then, force the pressing switch to drive the valve body 413 to open the channel. At the moment, the portable bidet sprayer sprays out the liquid by pressure change. The portable bidet sprayer is so small that users may take with it conveniently. Spaying velocity and amount of the liquid of the portable bidet sprayer are suitable for rinsing anus. Users can rinse their anuses by the portable bidet sprayer of the present invention after bowel movement without tissue paper.

Moreover, the portable bidet sprayer changes the atmospheric pressure of the receiving space 121 manually without consuming any power. It is quite practical and protects the environment as well. The structure of the portable bidet sprayer is so simple that the production cost would be reduced.

It is remarkable that after the atmospheric pressure of the receiving space 121 is quite high, the pressure element 20 is able to be fixed in the second position by the limiting member 31. At the present time, the pressure element 20 is received inside of the container 10, and the first end 21 of the pressure element 20 does not protrude from the container 10 too much. Whereby, the portable bidet sprayer is easier to be taken with users and operate manually.

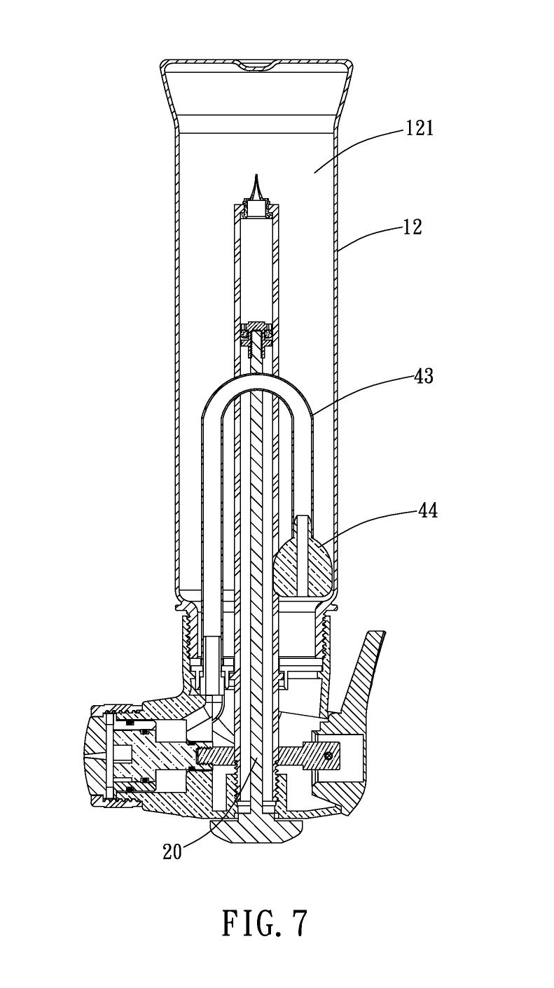

Note that the weight member 44 is disposed at the bottom end of the guide tube 43 and the guide tube 43 is flexible. As users rinses their anuses, they'll hold the portable bidet sprayer upside down, as shown in FIG. 7. At this time, the weight member 44 falls down by gravity, and the guide tube is bended by the weight member 44. Whereby, the guide tube 43 is able to draw liquid at any time, even the bottle 12 is turned upside down. That is to say, users can change the spraying angle of the portable bidet sprayer randomly, and the anuses would be rinsed cleaner.

Accordingly, the check valve 14 is disposed at the second end of the pipe 13, and the duckbill portion 142 narrows down towards the bottom portion of the bottle 12. Whereby, the duckbill portion 142 dose only allow air in the pipe to pass therethrough and into the receiving space 121, but not allow liquid in the receiving space 121 to pass therethrough and into the pipe 13. Now that the liquid is obstructed by the duckbill portion 142, users would not worry about the liquid flowing along the pipe 13 and the pressure element 20 and leaking out from the receiving groove 111.

What is claimed is:

1. A portable bidet sprayer, comprising:
a container, having a receiving space adapted for containing liquid;
a pressure element, disposed in the container and comprising a first end and a second end, the first end of the pressure element being located outside of the container, the second end of the pressure element being located inside of the container, the pressure element being able to move upwards and downwards between a first position and a second position with respect to the container, the first end of the pressure element being away from the container when the pressure element being located in the first position, the first end of the pressure element abutting against the container when the pressure element being located in the second position;
a fixation mechanism, disposed on the container, the pressure element being selectively fixed in the second position by the fixation mechanism;
a spraying device, disposed in the container and comprising a control valve and a nozzle, after the control valve being opened, the liquid in the receiving space flowing to the nozzle by pressure change and spraying out from the nozzle.

2. The portable bidet sprayer of claim 1, wherein the container is formed with a receiving groove, the fixation mechanism comprises a limiting member extending from an inner side wall of the receiving groove radially, the pressure element comprises an abutting member extending therefrom radially, the pressure element penetrates the receiving groove and is able to rotate around an axis with respect to the container, after the pressure element is located in the second position and further rotates around the axis in a distance, a top portion of the abutting member abuts against a bottom portion of the limiting member.

3. The portable bidet sprayer of claim 2, wherein the container comprises a head portion, the receiving groove is formed with on a top surface of the head portion.

4. The portable bidet sprayer of claim 1, wherein the spraying device comprises a guide tube and a weight member, the guide tube is flexible, the weight member is disposed at a bottom end of the guide tube, the weight member is formed with a through hole in communication between inside of the guide tube and the receiving space.

5. The portable bidet sprayer of claim 1, wherein the container comprises a pipe and a check valve, a part of pressure element is received in the pipe, the pipe has a first end and a second end, the check valve is disposed at the second end of the pipe.

6. The portable bidet sprayer of claim 5, wherein the check valve comprises a base portion and a duckbill portion, the base portion is disposed at the second end of the pipe, the duckbill portion extends from the base portion and gradually narrows down towards a bottom portion of the container.
